(19) United States
(12) Patent Application Publication
(10) Pub. No.: US 2009/0195652 A1
(43) Pub. Date: Aug. 6, 2009

(54) Interactive Virtual Window Vision System For Mobile Platforms

(75) Inventor: Ehud GAL, Reut (IL)

Correspondence Address: MARSTELLER & ASSOCIATES, P O BOX 803302, DALLAS, TX, 75380-3302, US

(73) Assignees: WAVE GROUP LTD., Tel Aviv (IL); O.D.F. OPTRONICS LTD., Tel Aviv (IL)

(21) Appl. No.: 12/365,631

(22) Filed: Feb. 4, 2009

(30) Foreign Application Priority Data
Feb. 5, 2008 (IL) 189251

(51) Int. Cl. H04N 7/18; G06F 19/00

(52) U.S. Cl. 348/148; 701/2; 348/E07.085

(57) ABSTRACT

The invention is a vision and image capture system for mobile platforms. The system comprises: an imaging sensor that comprises at least one imaging sub-sensor which is integrated in the outside walls of the platform; at least one display screen on which is displayed the images captured by the imaging sub-sensor; and a processing unit comprising hardware and software components for processing the gathered images, displaying them on the screen and optionally allowing other applications. The system of the invention is characterized in that the at least one imaging sub-sensor is mounted approximately at the height of the eyes of the operator of the system and at a predefined angle respective to the mobile platform matching the preferred viewing angle of the operator from his seat within the platform. This location and orientation of the imaging sub-sensor allows a life like simulation and presentation of the images on the screen to the operator as if he were looking at the scene through a transparent window in the side of the mobile platform.

### FIELD OF THE INVENTION

The present invention relates to the fields of Electro-optics and computerized vision. More specifically the invention relates to the fields of observation and imaging systems for mobile platforms.

### BACKGROUND OF THE INVENTION

Moving platforms usually include windows through which the operator observes the surroundings and operates the platform in relation to the events taking place around him. The simplest example is that of the windows found in the everyday vehicles that we drive. Most vehicles have windows at the front, on the sides and at the back, through which we observe our surroundings whilst driving in order to keep ourselves and others safe.

Despite the presence of windows surrounding the driver, there frequently occur situations, e.g. darkness, inadequate lighting, fog or stormy weather when it is difficult to understand everything that is taking place around the vehicle only by observation out of a window. For example, looking out of a side window of a vehicle at surroundings that are not properly lit, it will be hard to see everything that is taking place alongside of the vehicle.

As opposed to the types of mobile platforms described above, there are many types of mobile platform that are designed with few, very small, or no windows at all. These platforms are usually used for security and defense applications such as; armored personnel carriers, tanks, vehicles for transporting valuable commodities such as money, prisoner transport vehicles etc. The restricted field of view makes it hard for the operator of these platforms to become familiar with his surroundings and safely operate his vehicle. In order to provide the ability for the operator to become familiar with the surroundings these platforms can be equipped with different means e.g. mirrors, direction/range sensors, and cameras.

A variety of vision and imaging systems for manned mobile platforms exist today. A sample of typical prior art solutions follow:
U.S. Pat. No. 5,452,641 to Kariya describes an observation window for armored vehicles. The window comprises angled louvers that are fixed into an opening in the wall of the armored vehicle and a sheet of transparent material set into the interior side of the opening. The louvers have a light reflecting coating on their upper and lower surfaces and the angle is set to create an optical path that allows a person inside the vehicle to observe the surroundings outside of the vehicle. The louvers and transparent material are made of material that has sufficient strength to protect the personnel inside the vehicle from armament that is fired at the window. The observation window proposed in this patent provides only a partial solution to the problem of making available information concerning the surroundings of the vehicle to the personnel inside, since the field of view is limited to that allowed by the size and location of the window in the vehicle and any event taking place outside of this restricted field of view can not be observed.
Patent application US 2006/0262140 to Kujawa et al. describes a method and apparatus that is used to augment, i.e. emphasis the presence of pre-selected features in images in a scene that is viewed by an observer. The apparatus comprises one or more cameras that record electronic images of essentially the same scene, processing means that search the images for the pre-selected features, and projection and display means that project the augmented features on the “real” scene viewed by the observer. This patent teaches a method that assists the operator to see pre-selected features in a scene more clearly, but requires that the scene be directly viewed by the eyes of the viewer.
A more sophisticated system for allowing observation of outside events from within a windowless vehicle is the ODR system by ODF Optronics Ltd. Israel [www.odfopt.com]. This is an Omni-directional 360° system for vision and imaging of the occurrences around the vehicle. This system enables display of the surroundings on a screen which has a unique interface that allows the observer to become familiar with his surroundings, and to associate the information he is observing to its location in relation to the platform by using various icons and bars on the screen. The ODR system provides the operator with all the information that he needs to operate his mobile platform. A drawback of this system is that the images are taken with a non-natural downward viewing angle of the scene that does not supply the intuitive feeling of operating a vehicle having windows on all sides through which the surroundings can be viewed.

It is an object of the present invention to supply a vision and imaging system for manned mobile platforms, for intuitive surrounding orientation via a screen based interactive virtual window, on which the operator can see the occurrences outside the platform, as if looking through a transparent glass window.

It is an object of the present invention to supply a vision and imaging system for remote control over unmanned/robotic mobile platforms, which simulates intuitively the surroundings of the platform as if the remote operator was looking through a window from inside the platform.

It is another object of the present invention, to provide a system which is simple to integrate into mobile platforms in such a manner which saves space and which is easily accessible and stowed away when required.

It is another object of the present invention to provide a system which enables intuitive Omni Directional observation of the surroundings (360°) and orientation of the observed features relative to the mobile platform even under unfavorable environmental conditions such as insufficient lighting, darkness, stormy weather, or lack of windows in which human orientation abilities are severely limited.

It is another object of the present invention to supply a system that allows integration and synchronization with other systems located on the platform, thus making it easier for the operator of the system to control the platform and its devices, as well as improving the capabilities of the system itself by combining/fusing information with other systems.

It is yet another object of the current invention to provide a system with capacity to process an image which can support the operator's decision making process by using algorithms for understanding the image, which allow designation of relevant information from the information obtained by the system sensors as a whole based on predetermined and predefined parameters known to and/or defined by the operator.

Further objects and abilities of the system will become apparent as the description proceeds.

### SUMMARY OF THE INVENTION

In a first aspect the invention is a vision and image capture system for manned mobile platforms. The system comprises:
a. an imaging sensor that comprises at least one imaging sub-sensor which is integrated in the outside walls of the platform;
b. at least one display screen on which is displayed the images captured by the imaging sub-sensor; and
c. a processing unit comprising hardware and software components for processing the gathered images, displaying them on the screen and optionally allowing other applications.

The system of the invention is characterized in that the at least one imaging sub-sensor is mounted approximately at the height of the eyes of the operator of the system and at a predefined angle respective to the mobile platform matching the preferred viewing angle of the operator from his seat within the platform. This location and orientation of the imaging sub-sensor allows a life like simulation and presentation of the images on the screen to the operator as if he were looking at the scene through a transparent window.

In embodiments of the system of the invention that comprise more than one imaging sub-sensor integrated in the outside walls of the platform, the system may comprise more than one display screen. In one embodiment a display screen is located at the position corresponding to the location of each of the imaging sub-sensors. In another embodiment only one display screen is provided and it is physically or virtually moved alternately between positions corresponding to the positions of the imaging sub-sensors. The display screen can be moved along a curved track and, as the display screen moves along the track, the processing unit updates the images on the screen to display the view that would be seen through a window in the wall of the mobile platform corresponding to the direction the operator is looking at every point along the track.

In embodiments of the system of the invention the imaging sensor comprises a plurality of stationary imaging sub-sensors that are integrated in the outside walls of the platform. The imaging sub-sensors are positioned such that the fields of view of adjacent sub-sensors overlap and that together they capture images of all objects and events surrounding the mobile platform. In these embodiments the processing unit comprises hardware and software components that are configured to seamlessly stitch the images from the stationary imaging sub-sensors into a panoramic 360 degree view of the area surrounding the mobile platform.

Any of the embodiments of the system of the invention can comprise at least one pan-tilt-zoom (PTZ) imaging sub-sensor installed on the roof of the mobile platform. The PTZ sensor can be moved laterally, raised or zoomed in according to instructions given by the operator of the system in order to capture enlarged images of a selected region of interest (ROI).

The system may comprise one or more additional sensors, e.g. distance measuring sensors, microphones, space detectors, temperature detectors, and ABC (atomic, biological and chemical) sensors. The information gathered from the additional sensors can be integrated by the processing unit into the images displayed to the operator of the system.

The imaging sub-sensors can gather images in one or more of the ultra-violet, visible, near infra-red, or infra-red spectral regions. In embodiments of the system each sub-sensor is equipped with illumination means that enhance the ambient light in the appropriate spectral range. The illumination means can be based on Light Emitting Diodes (LEDs). One or more pairs of imaging sub-sensors can be attached to the mobile platform side by side in such a way that allows for the images obtained from both sub-sensors to be processed to create a three-dimensional image.

In embodiments of the system of the invention the display screen is a graphical user interface (GUI) on which is displayed the images gathered by the imaging sub-sensors and other information selected to improve the spatial orientation of the operator of the system, to familiarized him with his surroundings, and to assist him in intuitively analyzing the events which are taking place around him and in decision making.

In embodiments of the system the display screen is a touch screen. In embodiments of the system the default screen display may comprise a panoramic 360 degree view of the area surrounding the mobile platform and an enlarged image of a selected region of interest (ROI). The display screen can be curved and relatively wide in order to provide the user with a life-like panoramic view of the matching view outside of the mobile platform.

In embodiments of the system the processing unit comprises a movement detection algorithm to perform Video Motion Detection (VMD) for tracking objects in motion within the obtained images. The objects determined to be moving can be indicated on the display screen using tactical markings that can be intuitively understood by the operator of the system.

In embodiments of the system the processing unit and display screen are adapted to allow interfacing with existing systems on the mobile platform.

The system of the invention can comprise an additional means of imaging located inside the mobile platform and directed at the platform operator. The processing unit of the system is configured to process the information obtained from this interior imaging means to allow determination of the operator's direction of observation by measuring the orientation of the pupils in his eyes relative to some fixed reference frame and/or by measuring the angle of the tilt of his head. The processing unit uses these measurements to synchronize the information displayed on the display screen to always provide the view that would be seen through a window in the wall of the mobile platform corresponding to the direction the operator is looking.

Sensors that indicate the operator's viewing direction can be attached to his head and information from the sensors utilized by the processing unit of the system to continually update the view on the display screen to show the information that the operator would see if there were a window located at his present viewing direction.

In embodiments of the system of the invention the operator of the system sits on a seat that can rotate. The display screen is mechanically coupled to the seat such that the screen moves along a track together with the seat as a single unit. The rotation mechanism for the seat has a sensor attached to it that measures the angle of rotation and transmits this information to the processing unit of the system. The processing unit displays images on the display screen that simulate the scene that would be seen through an actual window at the position of the display screen at any given time.

In embodiments of the system of the invention the display screen is replaced with a miniature screen attached to the helmet of the operator of the system.

Embodiments of the system comprise communication means that enable the transmitting of information displayed on the display screen to additional locations in the mobile platform and/or communication means based on a wireless transmitter to transmit the obtained information to entities outside of the platform.

Embodiments of the system of the invention comprise a remote control station. In these embodiments the mobile platform comprises a transceiver for transmitting information from the mobile platform to the remote control station. The mobile platform also comprises an electro-mechanical mechanism executing control signals that are wirelessly transmitted from the control station to the mobile platform by a remote operator. Additional information from sensors installed on the mobile platform may also be wirelessly transmitted to the remote control station to assist the operator to control the mobile platform.

In a second aspect the invention is a manned mobile platform that comprises one or more vision and image capture systems according to the first aspect of the invention.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIG. 1 and FIG. 2 schematically show the basic embodiment of the vision and observation system of the invention;

FIG. 3 schematically shows an embodiment of the vision and observation system of the invention;

FIG. 4 schematically shows an embodiment of the interface screen of the system of the invention.

### DETAILED DESCRIPTION OF PREFERRED EMBODIMENTS

The present invention describes a vision and image capture system for mobile platforms, whether manned, unmanned, or robotic, including any type of motorized land vehicle, aircraft, and ship. The system of the invention is configured to assist the individual or the team using the platform or controlling it to become familiarized with their surroundings and to assist in analyzing the events which are taking place around them intuitively. This ability is provided to the operator of the platform by means of a virtual window through which the operator can observe the events outside as if he were looking through a transparent window inside the mobile platform. The system of the invention can be usefully employed with mobile platforms having very few or no windows as is the case with mobile platforms for security and defense applications or with mobile platforms having sufficient windows but visibility through them is impaired as a result of unfavorable external environmental conditions such as bad lighting, darkness, stormy weather, dirt, or dust. Especially when these and similar environmental conditions are present the use of imaging sensors with spectral sensitivity that is outside of the visible range together with matching illumination means will allow displaying of all information on the screen, which is needed to operate the mobile platform.

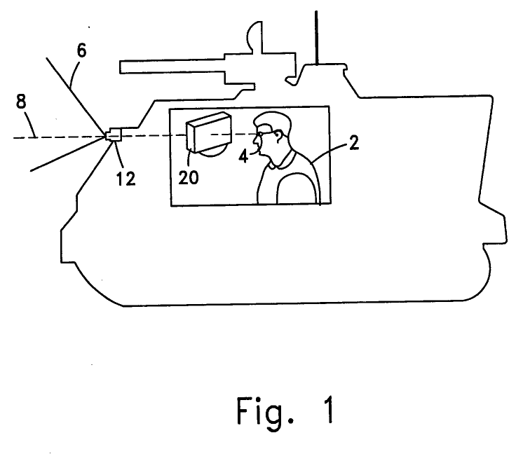

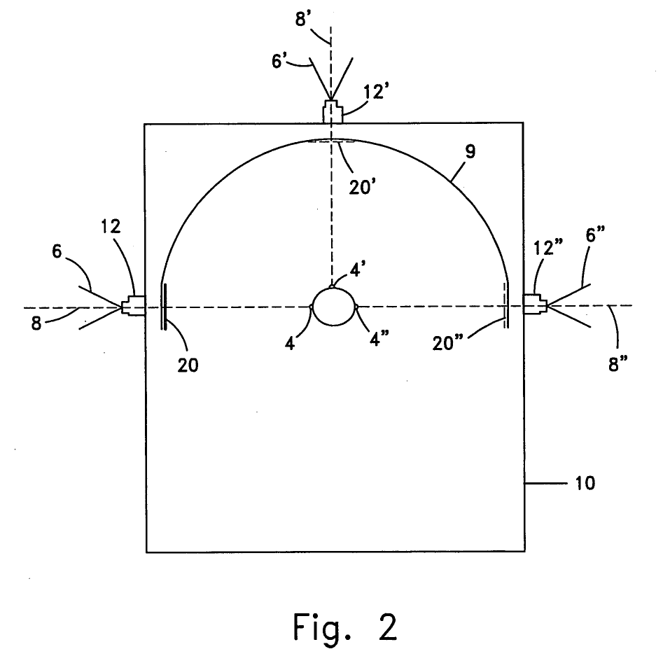

FIG. 1 and FIG. 2 schematically show the basic embodiment of the vision and observation system of the invention. FIG. 1 is a side view, which illustrates the principle on which the invention is based. Driver 2 sits inside of a mobile platform. For illustrative purposes only it is assumed in this case that he has normal unimpaired vision to the front, right side and rear of the platform but, for any of the reasons discussed hereinabove, his vision of the surroundings to his left is limited. To overcome this problem a system of the invention is installed to aid him in driving the platform. The system consists of an imaging sensor 12, a screen 20 on which the images gathered by imaging sensor 12 are displayed, and a processing unit (not shown in the figures) that comprises hardware and software components for processing the gathered images, displaying them on screen 20 and optionally allowing many other applications, some of which will be described hereinbelow.

Imaging sensor 12 is any type of electronic camera known in the art that is installed on the outside of the mobile platform. In the simplest case imaging sensor 12 is rigidly attached to the side of the platform pointing in a fixed direction that allows imaging of objects and events taking place within a fixed field of view 6. In order to allow as much of a life-like simulation and present the images to the operator as if he were looking at the scene through a window in the platform it is an essential feature of the invention that imaging device 12 be mounted at the exact height of the eyes 4 of the operator of the system and that the screen 20 be positioned such that, as shown in FIG. 1, a horizontal virtual line 8 drawn from the eyes 4 of driver 2 through the center of field of view 6 passes essentially through the center of screen 20. If these conditions are met, then the images can be displayed inside the platform in such a way that the operator has the intuitive feeling of looking through a virtual transparent window in the side of the platform that is located in the direction that he is looking.

FIG. 2 is a top view that illustrates a more complex embodiment than that shown in FIG. 1. In this case three imaging sensors 12, 12′, and 12″ are attached to the outside left, front, and right sides of mobile platform 10 as shown. In order to observe events and objects to the left on a screen located at the position of screen 20 the operator turns at least his head so that his eyes 4 look in direction 8. If he wants to see what is happening in front of him, he must turn so that his eyes 4′ are pointed in the direction 8′. At the same time a screen must be provided at the location of screen 20′ in the figure. Similarly, to view the surroundings on the right side of platform 10, the driver's eyes 4″ must look in direction 8″ and a screen provided at 20″. The driver can look in the different directions simply by turning his head or by rotating his whole body, for example by rotation of the chair on which he sits or a platform on which he stands. For the situation shown in FIG. 2, three separate screens can be provided located at positions within the mobile platform that are fixed relative to the external imaging devices and the head of the system operator. Alternatively, only one screen may be provided and physically or virtually moved alternately between positions 20, 20′, and 20″ by several different methods examples of which will be given hereinbelow. As a concrete example the screen can be manually moved by the operator by sliding it along a track symbolically shown by curved line 9.

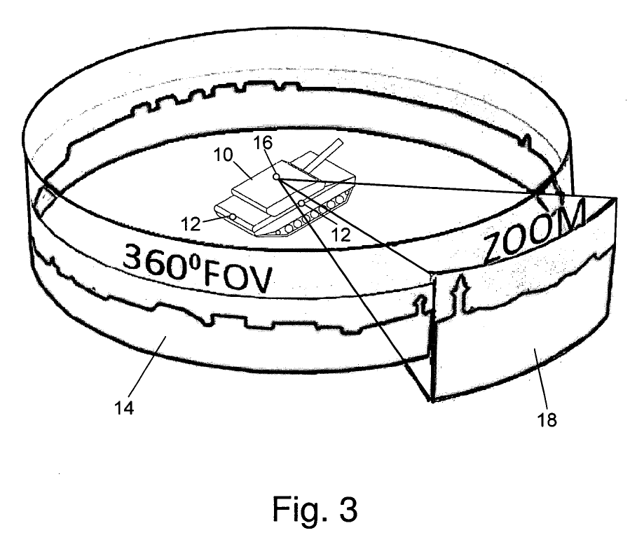

FIG. 3 schematically shows an embodiment of the vision and observation system of the invention comprising an imaging sensor that includes sub-sensors for omni-directional orientation. For example, if the manned mobile platform is tank 10, the imaging sensor is comprised of a plurality, e.g. four, stationary imaging sub-sensors, i.e. video cameras, 12 that are integrated in the side walls of the platform. The processing unit of the system of the invention comprises software enabled to seamless stitch the images from cameras 12 into a panoramic 360 degree view 14 of the area surrounding tank 10.

In order to meet the conditions of the invention, the cameras must be integrated into the outside of the tank at the height above ground at which an “average sized” crew member, e.g. driver, weapons system operator, or commander who will be operating the system normally sits or stands and at a position on the side of the mobile platform matching the average viewing angle of the driver from his seat within the platform. Matching a specific angle for a specific operator, which may be different from the average setting, can be done by synchronizing the components of the system manually, i.e. by moving the touch screen or moving the imaging sensor laterally, or electronically by adjusting the interface obtained information on the touch screen to that specific operator. In addition “fine tuning” must be provided to adjust the height of the operator's eyes to the height of the cameras, for example by raising or lowering the seat on which the operator sits.

The synchronization methods described above can be applied mutatis mutandis to the case of a remote operator in order to enable intuitive remote control over an unmanned/robotic platform. In such embodiments the images captured by the sub sensors are wirelessly transmitted to a remote control station where they are displayed on a screen to the remote operator. The remote operator can synchronize the system using methods described above in order to enable a life-like simulation of the surroundings. In other words, the system provides a remote life-like simulator to enhance the operator's ability to understand the surroundings of the platform and to control it from a distance.

At least one additional imaging sub-sensor 16 of the Pan, Tilt, Zoom (PTZ) type is installed on the roof of the platform 10. This sensor can be moved laterally, raised or zoomed in according to instructions given by the platforms' operator in order to capture enlarged images of a selected region of interest (ROI) 18 in the panoramic scene 14. The images obtained from ROI 18 can also be displayed on the screen in the platform to resemble looking through a window (hereinafter “Natural Presentation”).

The imaging sensor can comprise sub-sensors that gather information in different spectral regions, e.g. ultraviolet, visible, near infra-red, and infra-red, to allow information gathering both during the day and at night. Additionally each sub-sensor can be equipped with illumination means that enhance the ambient light in the appropriate spectral range. Preferably the illumination means are based on Light Emitting Diodes (LEDs).

In an embodiment of the invention one or more pairs of imaging sub-sensors are attached to the mobile platform side by side in such a way that allows for the images obtained from both sub-sensors to be processed to create a three-dimensional image.

The system of the invention also preferably includes additional sensors, e.g. distance measuring sensors, microphones, space detectors, that are attached to the exterior of the mobile platform. The information gathered from these additional sensors can be integrated into the images displayed to the operator as will be described hereinbelow.

On top of the Natural Presentation images of the surroundings of the mobile platform that are obtained by the imaging sensors, image processing and other techniques can be used to add additional information in order to assist the operator in decision making and/or to provide advanced warnings of obstacles etc. All of this information and more is made available to the operator by means of a processing unit comprising various hardware and software components, memory components, communication components, and a physical device on which the images and information are displayed to the operator.

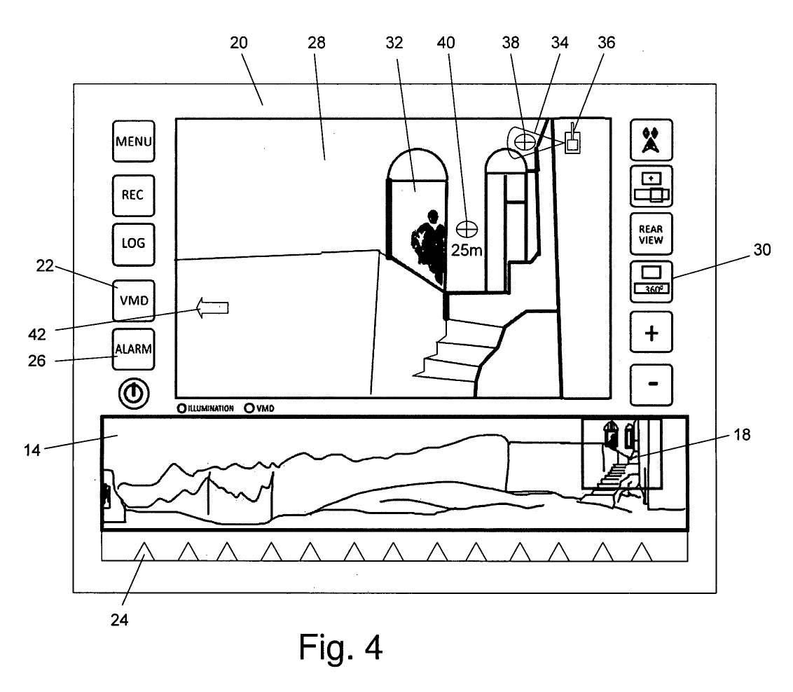

FIG. 4 schematically shows an embodiment of a touch screen graphical user interface 20 of the system of the invention. Interface 20 is designed to improve the spatial orientation of the operator in handling the mobile platform and to assist him in decision making. By touching button 30 the operator obtains the default display shown in the figure. The default is the Natural Presentation, i.e. the information is viewed by the operator as if he were looking through a window. In the default view the omni directional information that is obtained by the imaging sub-sensors is “stitched together” and displayed as an integral and complete panoramic scene 14 on the interface screen 20. In order to assist the operator to become familiar with the omni-directional surroundings, that is to say, in order to understand where every detail in the image is in relation to the platform, the interface provides different rulers 24. The operator can choose a region of interest 18 in the panoramic scene 22. An enlarged detailed image 28 of the selected ROI is displayed on interface 20 in the upper part of the screen above panoramic view 14.

In an embodiment of the invention the display screen is curved and relatively wide in order to provide the user with a life-like panoramic view of the matching view outside of the mobile platform.

In embodiments of the invention, the system includes a movement detection algorithm to perform Video Motion Detection (VMD) for tracking objects in motion within the obtained images. The objects determined to be moving are then indicated on interface 20 using tactical markings that can be intuitively understood by the operator. For example, arrow 42 indicates an object located outside of the presently selected ROI that is moving away from the mobile platform. The operator can choose to shift the ROI to determine the nature of the moving object or to ignore it.

Embodiments of the system are configured to allow interfacing with existing systems on the platform, e.g. weapons systems or GPS navigational systems and integrating the information between them. This processed information can be displayed on the Natural Presentation for the convenience of the operator to enable him to control all the different systems that exist within the platform via the interface on the screen.

As an example of the type of information that can be determined from the images supplied by the imaging sensor, tactical markings 11, 12, and 13 on interface 20 respectively show the operator the direction in which he is looking in relation to the platform as well as the location of a moving object (the man in the doorway) in relation to his direction of observation. In the embodiment shown a range measurement detector is incorporated. The operator simply points at (touches) the object on the screen to which he wishes to measure the range and the range is displayed beside that object 40. The interface then allows directing weapons systems towards the object designated by the operator.

The operator can also request (button 26) that the system display indications that are obtained from complimentary external sensors, e.g. microphones, temperature detectors, space detectors, or ABC (atomic, biological and chemical) sensors.

The system also includes a memory component that enables saving information obtained from the imaging and other sensors fully or selectively. The information can be retrieved and used by the processing unit in applications such as those that analyze images for navigation purposes or issue warnings about threats or suspicious objects.

In order to accomplish the main goal of the invention, i.e. to supply a vision and imaging system for mobile platforms, for intuitive surrounding orientation via a screen based interactive virtual window, on which the operator can see the occurrences outside the platform, as if looking through a transparent glass window, it is necessary to synchronize the Natural Presentation with the direction in which the operator is looking or would like to look. This can be accomplished in a number of ways, a few of which are now described:
The screen is stored in a compartment located adjacent to the location inside the tank that the operator will sit or stand. When the use of the system is needed, the screen is pulled out and locks into a mechanism to the left of the platform operator, the information that is displayed as default on the screen is the Natural Presentation the operator would see if he had a window in the left side wall of the platform. The bottom of the screen is attached to a curved track that surrounds the operator and the operator can manually change the position of the screen by pushing it along the track. As it moves along the track the processing unit update the images on the screen to display the obtained Natural Presentation at every point along the track as if there were a window in the wall of the tank corresponding to the direction the operator is looking.
The system may include an additional means of imaging located inside the mobile platform, e.g. a video camera, which is directed at the platform operator. The processing unit of the system is configured to process the information obtained from this interior imaging means to allow determination of the operator's direction of observation by measuring the orientation of the pupils in the operator's eyes relative to some fixed reference frame and/or by measuring the angle of the head tilt. By calculating these parameters, the system is able to synchronize the information displayed on the screen to always provide the desired Natural Presentation that would be seen through a window in the wall of the mobile platform corresponding to the direction the operator is looking.
Another option is to attach sensors that indicate the operator's viewing direction to his head by some means, such as attaching the sensors to a cap or helmet worn by the operator. The information from these sensors is utilized by the processor of the system to continually update the Natural Presentation to show the information that the operator would be seeing if there were a window at his present viewing direction.
In another embodiment, the operator of the system sits on a seat that can rotate. The screen is mechanically coupled to the chair and moves along a track together with the chair as a single unit. A sensor connected to the rotation mechanism measures the angle of rotation and transmits this information to the processing unit, which displays images on the display screen to simulate the scene that would be seen through an actual window at the position of the screen at any given time.
In another method the touch screen 20 is replaced with a miniature screen attached to the operator's helmet, e.g. a “heads-up” display used by airplane pilots, and the information is displayed on it. In such a system can have an embodiment in which only a default display, e.g. the panoramic and zoomed views are displayed, or input means can be provided to allow the operator to actively change the display to obtain different types of information that might be needed by him.

The synchronization methods described above can be applied mutatis mutandis to the case of a remote operator in order enable intuitive remote control over an unmanned/robotic platform. In such embodiments other information gathered by sensors installed in the unmanned/robotic platform such as azimuth and acceleration sensors can be wirelessly transmitted to the remote control station in order to enhance the life-like simulation to the remote operator during maneuvers, e.g. curves, turns, and changes of speed, which are performed by the mobile platform. The control signals transmitted by the remote operator are received and processed at the mobile platform using an electro-mechanical mechanism.

The system of the invention comprises a connection to a source of electrical power to enable operation of its various components. The power source can an independent power pack but is preferably the electrical circuit of the mobile platform.

Embodiments of the system comprise communication means that enables the transmitting of information displayed on the display screen to additional locations in the platform and/or communication means based on a wireless transmitter to transmit the obtained information to entities outside of the platform.

Thee system of the invention can obviously be built into new mobile platforms, but also virtually no structural changes are required to retrofit existing platforms with the added capabilities provided by the invention. A given manned mobile platform can be equipped with two or more touch screen graphical user interfaces, all of which display images gathered by the same imaging sensor, and optionally sharing a common processing unit.

Each of the interfaces can be adapted to provide only the information relative to the specific task of the crew member that is using it.

Although embodiments of the invention have been described in relation to a specific type of mobile platform by way of illustration, it will be understood that the invention may be carried out with many variations, modifications, and adaptations, without exceeding the scope of the claims.

1. A vision and image capture system for mobile platforms comprising:
a. an imaging sensor that comprises at least one imaging sub-sensor which is integrated in the outside walls of said platform;
b. at least one display screen on which is displayed the images captured by said imaging sub-sensor; and
c. a processing unit comprising hardware and software components for processing the gathered images, displaying them on said screen and optionally allowing other applications;
said system characterized in that said at least one imaging sub-sensor is mounted approximately at the height of the eyes of the operator of said system and at a predefined angle respective to said mobile platform matching the preferred viewing angle of said operator from his seat within said platform, thereby allowing a life like simulation and presentation of the images on said screen to said operator as if he were looking at the scene through a transparent window.

2. The system of claim 1 comprising more than one imaging sub-sensor integrated in the outside walls of said platform, said system comprising more than one display screens, wherein one of said display screens is located at the position corresponding to the location of each of said imaging sub-sensors.

3. The system of claim 1 comprising more than one imaging sub-sensor integrated in the outside walls of said platform, said system comprising one display screen that is physically or virtually moved alternately between positions between positions corresponding to the positions of said imaging sub-sensors.

4. The system of claim 1 comprising:
a. an imaging sensor comprising a plurality of stationary imaging sub-sensors that are integrated in the outside walls of said platform, wherein said imaging sub-sensors are positioned such that the fields of view of adjacent sub-sensors overlap and that together they capture images of all objects and events surrounding the mobile platform; and
b. hardware and software components in the processing unit that are configured to seamlessly stitch the images from said stationary imaging sub-sensors into a panoramic 360 degree view of the area surrounding said mobile platform.

5. The system of claim 1 comprising at least one pan-tilt-zoom (PTZ) imaging sub-sensor installed on the roof of the mobile platform, wherein said PTZ sensor can be moved laterally, raised or zoomed in according to instructions given by the operator of said system in order to capture enlarged images of a selected region of interest (ROI).

6. The system of claim 4 comprising at least one pan-tilt-zoom (PTZ) imaging sub-sensor installed on the roof of the mobile platform, wherein said PTZ sensor can be moved laterally, raised or zoomed in according to instructions given by the operator of said system in order to capture enlarged images of a selected region of interest (ROI).

7. The system of claim 1 comprising one or more additional sensors, wherein the information gathered from said additional sensors can be integrated by the processing unit into the images displayed to the operator of said system.

8. The system of claim 7 wherein the additional sensors are selected from: distance measuring sensors, microphones, space detectors, temperature detectors, and ABC (atomic, biological and chemical) sensors.

9. The system of claim 1 wherein the imaging sub-sensors can gather images in one or more of the ultra-violet, visible, near infra-red, or infra-red spectral regions.

10. The system of claim 9 wherein each sub-sensor is equipped with illumination means that enhance the ambient light in the appropriate spectral range.

11. The system of claim 10 wherein the illumination means are based on Light Emitting Diodes (LEDs).

12. The system of claim 1 wherein one or more pairs of imaging sub-sensors are attached to the mobile platform side by side in such a way that allows for the images obtained from both sub-sensors to be processed to create a three-dimensional image.

13. The system of claim 1 wherein the display screen is a graphical user interface (GUI) on which is displayed the images gathered by the imaging sub-sensors and other information selected to improve the spatial orientation of the operator of said system, to familiarized him with his surroundings, and to assist him in intuitively analyzing the events which are taking place around him and in decision making.

14. The system of claim 1 wherein the display screen is a touch screen.

15. The system of claim 6 wherein the default screen display comprises the panoramic 360 degree view of the area surrounding said mobile platform and an enlarged image of a selected region of interest (ROI).

16. The system of claim 4 wherein the display screen is curved and relatively wide in order to provide the user with a life-like panoramic view of the matching view outside of the mobile platform.

17. The system of claim 1 wherein the processing unit comprises a movement detection algorithm to perform Video Motion Detection (VMD) for tracking objects in motion within the obtained images, wherein the objects determined to be moving are then indicated on the display screen using tactical markings that can be intuitively understood by the operator of said system.

18. The system of claim 1 wherein the processing unit and display screen are adapted to allow interfacing with existing systems on the mobile platform.

19. The system of claim 3 wherein the one display screen is moved along a curved track, wherein as said display screen moves along said track the processing unit updates the images on said screen to display, at every point along said track, the view that would be seen through a window in the wall of the mobile platform corresponding to the direction the operator is looking.

20. The system of claim 1 comprising an additional means of imaging located inside the mobile platform, which is directed at the platform operator, wherein the processing unit of said system is configured to process the information obtained from said interior imaging means to allow determination of said operator's direction of observation by measuring the orientation of the pupils in his eyes relative to some fixed reference frame and/or by measuring the angle of the tilt of his head, wherein said processing unit uses these measurements to synchronize the information displayed on the display screen to always provide the view that would be seen through a window in the wall of the mobile platform corresponding to the direction said operator is looking.

21. The system of claim 1 wherein sensors that indicate the operator's viewing direction are attached to his head the information from said sensors is utilized by the processing unit of said system to continually update the view on the display screen to show the information that said operator would see if there were a window located at his present viewing direction.

22. The system of claim 1 wherein the operator of said system sits on a seat that can rotate, the display screen is mechanically coupled to said seat such that said screen moves along a track together with said seat as a single unit, the rotation mechanism for said seat has a sensor attached to it that measures the angle of rotation and transmits this information to the processing unit of said system, and said processing unit displays images on said display screen that simulate the scene that would be seen through an actual window at the position of said display screen at any given time.

23. The system of claim 1 wherein the display screen is replaced with a miniature screen attached to the helmet of the operator of said system.

24. The system of claim 1 comprising communication means that enables the transmitting of information displayed on the display screen to additional locations in the mobile platform and/or communication means based on a wireless transmitter to transmit the obtained information to entities outside of the platform.

25. A manned mobile platform comprising one or more vision and image capture systems according to claim 1.

26. The system of claim 24, wherein said system comprises a remote control station and the mobile platform comprises a transceiver for transmitting information from said mobile platform to said remote control station, said mobile platform also comprising an electro-mechanical mechanism execute control signals that are wirelessly transmitted from said control station to said mobile platform by a remote operator.

27. The system of claim 26, wherein additional information from sensors installed on the mobile platform is wirelessly transmitted to the remote control station to assist the remote operator in controlling said mobile platform.
